(19) United States
(12) Patent Application Publication
(10) Pub. No.: US 2024/0230431 A1
(43) Pub. Date: Jul. 11, 2024

(54) LOAD SENSOR

(71) Applicant: Panasonic Intellectual Property Management Co., Ltd., Osaka (JP)

(72) Inventors: Yuta MORIURA, Osaka (JP); Susumu URAGAMI, Kumamoto (JP); Takashi MATSUMOTO, Osaka (JP); Hironobu UKITSU, Osaka (JP); Yodai MATSUMURA, Osaka (JP)

(21) Appl. No.: 18/613,811

(22) Filed: Mar. 22, 2024

Related U.S. Application Data
(63) Continuation of application No. PCT/JP2022/014176, filed on Mar. 24, 2022.

(30) Foreign Application Priority Data
Sep. 24, 2021 (JP) 2021-155977

(51) Int. Cl. G01L 1/14

(52) U.S. Cl. CPC G01L 1/142

(57) ABSTRACT

A load sensor includes: a base member; a plurality of electrically-conductive elastic bodies disposed on an upper face of the base member and arranged in a first direction with a predetermined gap therebetween; a plurality of electrically-conductive members each having a linear shape and extending in a second direction, the plurality of electrically-conductive members crossing the plurality of electrically-conductive elastic bodies; and a dielectric body disposed between the electrically-conductive elastic body and the electrically-conductive member.

### CROSS REFERENCE TO RELATED APPLICATION

This application is a continuation of International Application No. PCT/JP2022/014176 filed on Mar. 24, 2022, entitled “LOAD SENSOR”, which claims priority under 35 U.S.C. Section 119 of Japanese Patent Application No. 2021-155977 filed on Sep. 24, 2021, entitled “LOAD SENSOR”. The disclosures of the above applications are incorporated herein by reference.

### BACKGROUND OF THE INVENTION

### Field of the Invention

The present invention relates to a load sensor which detects a load applied from outside, based on change in capacitance.

DESCRIPTION OF RELATED ART

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2020/079995 describes a pressure-sensitive element (load sensor) including: a plurality of first electrodes each implemented by an elastic body that is electrically conductive; a plurality of second electrodes each implemented by an electrically-conductive member having a linear shape; and a dielectric body covering the surface of each second electrode. The plurality of first electrodes and the plurality of second electrodes are disposed so as to cross each other in a plan view. An insulating part implemented by an insulative elastic body is disposed between the plurality of first electrodes. The plurality of first electrodes and a plurality of the insulating parts are integrated, whereby an elastic sheet is formed.

In this configuration, when a load applied to each crossing position between a first electrode and a corresponding second electrode increases, the contact area between the first electrode and the dielectric body increases at the crossing position. In association therewith, the capacitance between the first electrode and the second electrode increases. Therefore, by detecting the value of the capacitance between the first electrode and the second electrode for each crossing position, it is possible to detect the load applied to the crossing position.

In the above configuration, normally, as compared with elastic deformation of an electrically-conductive elastic body (first electrode) during load application, the speed of elastic return of the electrically-conductive elastic body during load release is slow. Accordingly, between during load application and during load release, a shift is caused in the relationship between the load and the capacitance. Therefore, when loads are detected both during load application and during load release, it becomes difficult to smoothly and appropriately detect the loads.

### SUMMARY OF THE INVENTION

A load sensor according to a main aspect of the present invention includes: a base member; a plurality of electrically-conductive elastic bodies disposed on an upper face of the base member and arranged in a first direction with a predetermined gap therebetween; a plurality of electrically-conductive members each having a linear shape and extending in a second direction, the plurality of electrically-conductive members crossing the plurality of electrically-conductive elastic bodies; and a dielectric body disposed between the electrically-conductive elastic body and the electrically-conductive member.

In the load sensor according to the present aspect, a plurality of electrically-conductive elastic bodies are disposed with a gap therebetween, and thus, the placement space of the electrically-conductive elastic bodies relative to the upper face of the base member is suppressed. Therefore, the structure composed of the base member and the electrically-conductive elastic body is more likely to quickly undergo elastic return during load release. As a result, the relationship between the load and the capacitance during load release can be brought close to the relationship between the load and the capacitance during load application. Therefore, it is possible to suppress occurrence of a shift in the relationship between the load and the capacitance between during load application and during load release.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1A is a perspective view schematically showing a base member on the lower side and electric conductors set on the upper face of the base member on the lower side, according to an embodiment;

FIG. 1B is a perspective view schematically showing a state where electrically-conductive elastic bodies are disposed on the structure in FIG. 1A, according to the embodiment;

FIG. 2A is a perspective view schematically showing a state where conductor wires are disposed on the structure in FIG. 1B, according to the embodiment;

FIG. 2B is a perspective view schematically showing a state where a base member on the upper side is set on the structure in FIG. 2A, according to the embodiment;

FIG. 3A and FIG. 3B each schematically show a cross section of a sensor part, according to the embodiment;

FIG. 4 is a plan view schematically showing the configuration of the inside of a load sensor, according to the embodiment;

FIG. 5 is a plan view schematically showing the configuration of the inside of a load sensor, according to Comparative Example;

FIG. 6 is a graph schematically showing an example of temporal change of capacitance during load application and during load release, according to Comparative Example;

FIG. 7A is a graph schematically showing the relationship between load and capacitance, according to Comparative Example;

FIG. 7B is a graph schematically showing the relationship between load and capacitance, according to the embodiment;

FIG. 8A and FIG. 8B each describe a preferable range in the Y-axis direction of the conductor wire, according to the embodiment;

FIG. 9A and FIG. 9B each describe a preferable range in the Y-axis direction of the conductor wire, according to the embodiment;

FIG. 10A and FIG. 10B each describe a preferable relationship between the widths in the X-axis direction of the electrically-conductive elastic body and the electric conductor, according to the embodiment;

FIG. 11 is a plan view schematically showing the configuration of the inside of a load sensor, according to a modification; and

FIG. 12A and FIG. 12B respectively schematically show cross sections of a sensor part, according to modifications.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiment below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiment below is connected to a detection circuit, and the load sensor and the detection circuit form a load detection device. The embodiment below is an example of embodiments of the present invention, and the present invention is not limited to the embodiment below in any way.

Hereinafter, an embodiment of the present invention will be described with reference to the drawings. For convenience, X-, Y-, and Z-axes orthogonal to each other are indicated in the drawings. The Z-axis direction is the height direction of a load sensor 1.

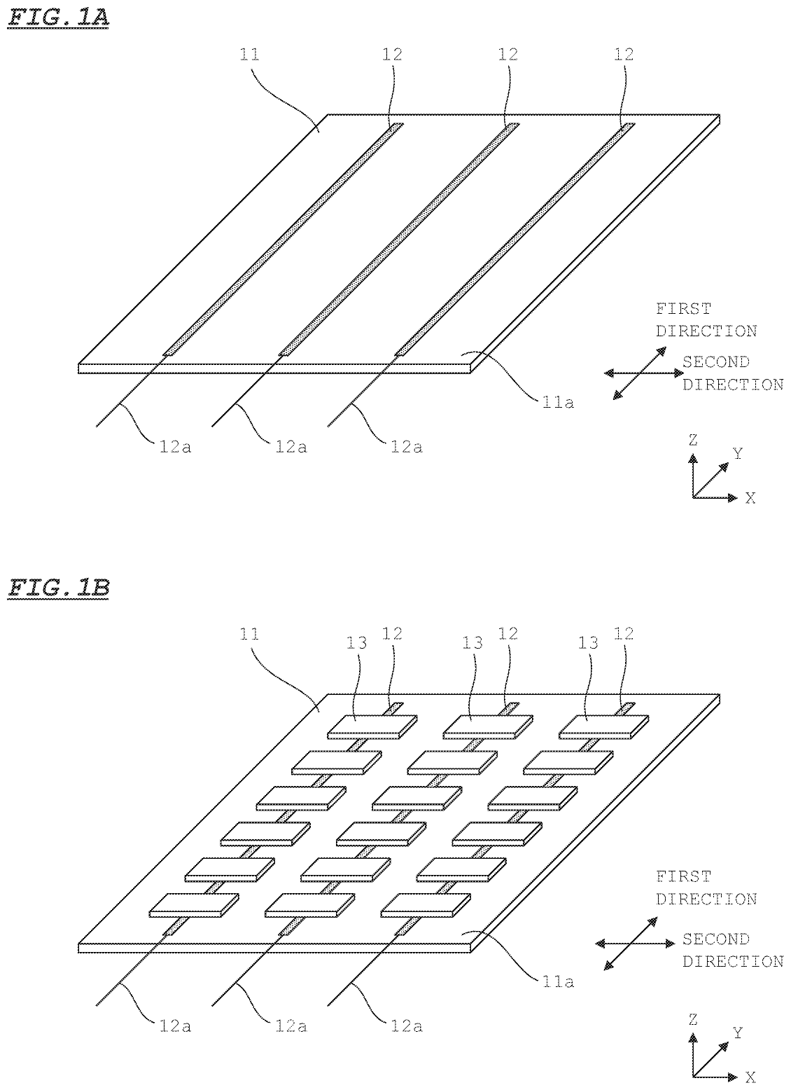

FIG. 1A is a perspective view schematically showing a base member 11 and electric conductors 12 set on an upper face 11a (the face on the Z-axis positive side) of the base member 11.

The base member 11 is an insulative flat-plate-shaped member having elasticity. The base member 11 has a rectangular shape in a plan view. The thickness of the base member 11 is constant. When the thickness of the base member 11 is small, the base member 11 may be referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electric conductors 12 are disposed on the upper face 11a of the base member 11. Here, three electric conductors 12 are disposed on the upper face 11a of the base member 11 so as to extend in a first direction (the Y-axis direction). Each electric conductor 12 is made of a material having a resistance lower than that of an electrically-conductive elastic body 13 described later. In the present embodiment, each electric conductor 12 is a member that is electrically conductive and that has elasticity. The thickness of the electric conductor 12 is smaller than the thickness of the electrically-conductive elastic body 13 described later. To an end portion on the Y-axis negative side of each electric conductor 12, a cable 12a electrically connected to the electric conductor 12 is set.

FIG. 1B is a perspective view schematically showing a state where the electrically-conductive elastic bodies 13 are disposed on the structure in FIG. 1A.

The electrically-conductive elastic bodies 13 are formed on the upper face 11a of the base member 11 so as to cover the electric conductors 12. Each electrically-conductive elastic body 13 is formed on the upper face 11a such that the electric conductor 12 is positioned at a substantially middle position of the electrically-conductive elastic body 13 in a second direction (the X-axis direction). The electrically-conductive elastic bodies 13 are formed so as to be arranged in the first direction (Y-axis direction) with a predetermined gap therebetween. Here, six electrically-conductive elastic bodies 13 are formed in the Y-axis direction. In addition, rows each composed of a plurality of the electrically-conductive elastic bodies 13 arranged in the Y-axis direction are formed so as to be arranged in the X-axis direction with a predetermined gap therebetween. Here, three rows each composed of a plurality of the electrically-conductive elastic bodies 13 arranged in the Y-axis direction are formed in the X-axis direction.

Each electrically-conductive elastic body 13 is a member that is electrically conductive and that has elasticity. Each electric conductor 12 and the corresponding row composed of a plurality of the electrically-conductive elastic bodies 13 arranged in the Y-axis direction formed so as to cover the electric conductor 12 are in a state of being electrically connected to each other.

Here, each electric conductor 12 and each electrically-conductive elastic body 13 are formed on the upper face 11a of the base member 11 by a printing method such as screen printing, gravure printing, flexographic printing, offset printing, or gravure offset printing. After the electric conductor 12 is formed as shown in FIG. 1A, the electrically-conductive elastic body 13 is formed so as to overlap with the electric conductor 12 as shown in FIG. 1B. With these printing methods, the electric conductor 12 and the electrically-conductive elastic body 13 can be formed so as to have a thickness of about 0.001 mm to 0.5 mm on the upper face 11a of the base member 11. However, the forming method for the electric conductor 12 and the electrically-conductive elastic body 13 is not limited to the printing method above.

The electric conductor 12 and the electrically-conductive elastic body 13 are each formed from a resin material and an electrically-conductive filler dispersed therein, or from a rubber material and an electrically-conductive filler dispersed therein.

Similar to the resin material used in the base member 11 described above, the resin material used in the electric conductor 12 and the electrically-conductive elastic body 13 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the base member 11 described above, the rubber material used in the electric conductor 12 and the electrically-conductive elastic body 13 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electric conductor 12 and the electrically-conductive elastic body 13 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

In the embodiment, the electrically-conductive filler used in the electric conductor 12 is Ag (silver). In this case, the resistivity of the electric conductor 12 is not greater than 9×10³ [Ω·cm]. The width in the X-axis direction of the electric conductor 12 is not less than 10 μm, for example, and the electric conductor 12 is configured such that the width in the X-axis direction thereof is smaller than that of the electrically-conductive elastic body 13. In the embodiment, the electrically-conductive filler forming the electrically-conductive elastic body 13 is C (carbon). In this case, the resistivity of the electrically-conductive elastic body 13 is not less than 1×10⁻² [Ω·cm].

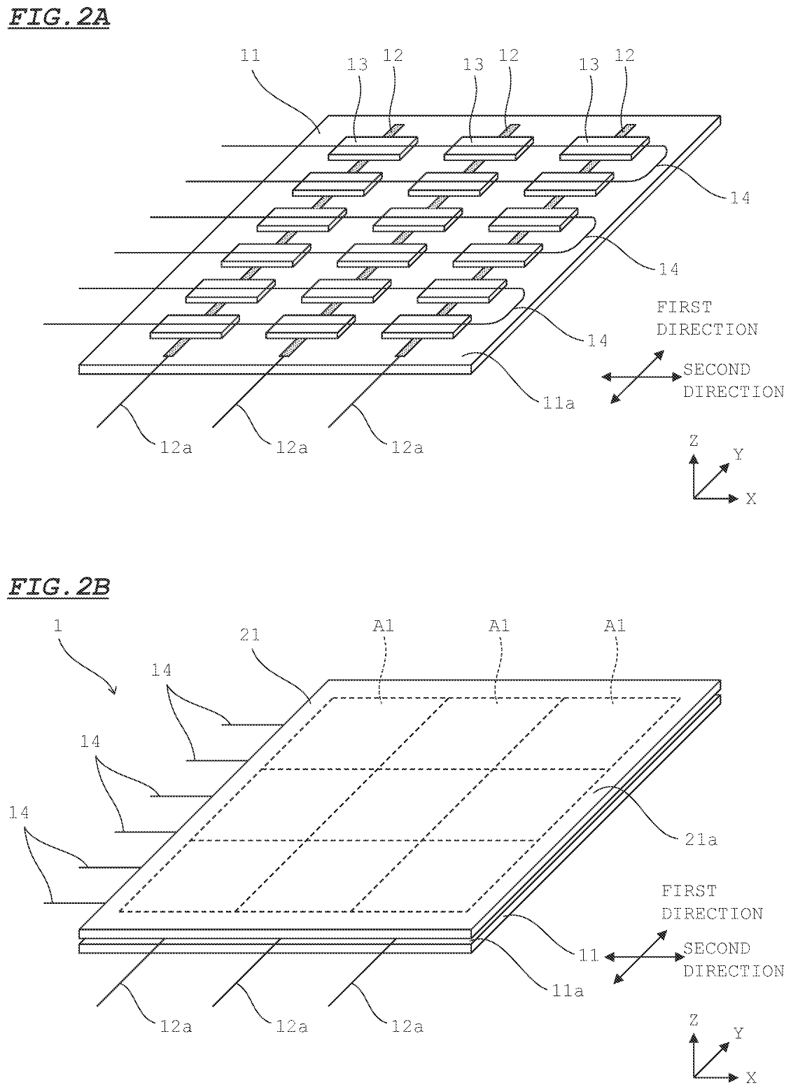

FIG. 2A is a perspective view schematically showing a state where conductor wires 14 are disposed on the structure in FIG. 1B.

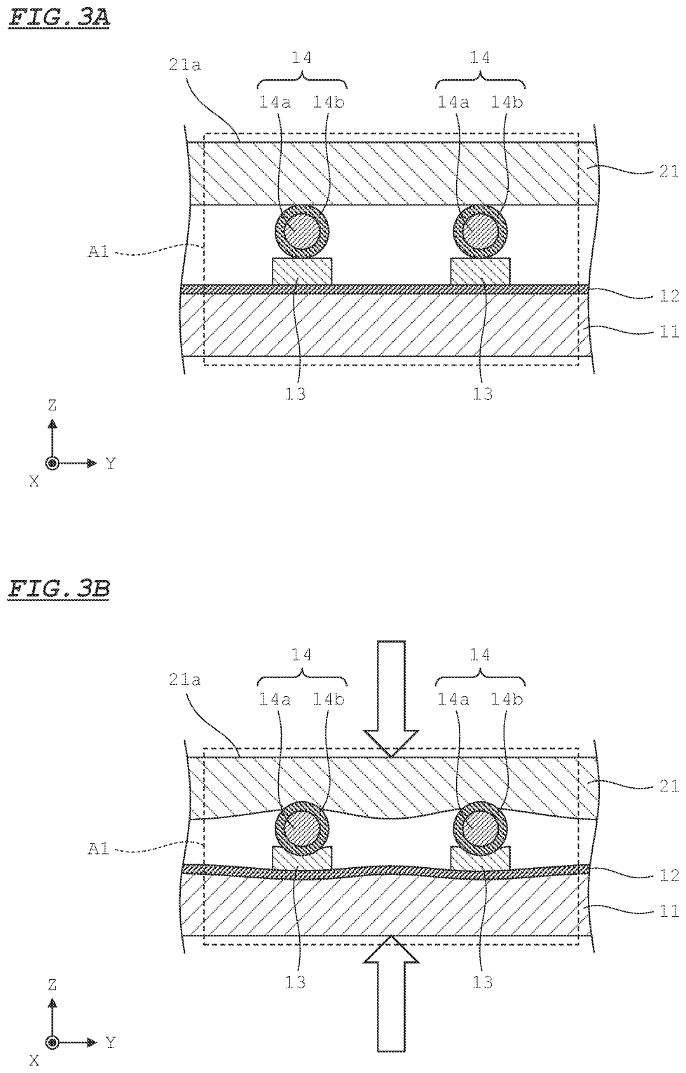

Each conductor wire 14 has a linear shape and extends in the second direction (the X-axis direction). The conductor wire 14 is bent near an end portion on the X-axis positive side of the base member 11. As a result of the conductor wire 14 being bent, two conductor wires 14 adjacent to each other in the first direction (the Y-axis direction) serve as a pair of the conductor wires 14. Here, three pairs of the conductor wires 14 are disposed so as to extend in the X-axis direction. Each conductor wire 14 is disposed so as to be superposed on the upper faces of three electrically-conductive elastic bodies 13 arranged in the X-axis direction, so as to cross the three electrically-conductive elastic bodies 13. Each conductor wire 14 is composed of an electrically-conductive member having a linear shape and a dielectric body formed so as to cover the surface of the electrically-conductive member. The configuration of the conductor wire 14 will be described later with reference to FIGS. 3A, 3B.

After a plurality of the conductor wires 14 have been disposed as in FIG. 2A, each conductor wire 14 is loosely sewn by a thread to the base member 11 so as to be moveable in the longitudinal direction (the X-axis direction). The thread in this case is implemented by a chemical fiber, a natural fiber, a mixed fiber of the chemical fiber and the natural fiber, or the like.

FIG. 2B is a perspective view schematically showing a state where a base member 21 is set on the structure in FIG. 2A.

The base member 21 has a configuration similar to that of the base member 11. The base member 21 has the same size and shape as those of the base member 11, and is formed from the same material as that of the base member 11. The base member 21 is disposed from above (the Z-axis positive side) the structure shown in FIG. 2A. Then, the outer peripheral portion of the base member 21 is connected to the outer peripheral portion of the base member 11 with a silicone rubber-based adhesive, a thread, or the like, for example. Accordingly, the base member 11 and the base member 21 are fixed to each other. Accordingly, the load sensor 1 is completed as shown in FIG. 2B.

The load sensor 1 may be used upside down from the state in FIG. 2B. In this case, the base member 21 need not necessarily be formed from a material similar to that of the base member 11, and may be formed from a hard material that is less likely to be elastically deformed, for example.

Here, in the load sensor 1, in a plan view, a plurality of sensor parts A1 arranged in a matrix shape are formed. In the load sensor 1 above, a total of nine sensor parts A1 arranged in the second direction (the X-axis direction) and the first direction (the Y-axis direction) are formed. One sensor part A1 corresponds to a region including an intersection between two electrically-conductive elastic bodies 13 adjacent to each other in the Y-axis direction and two conductor wires 14 respectively disposed on the upper faces of these two electrically-conductive elastic bodies 13.

That is, one sensor part A1 includes the electric conductor 12, the electrically-conductive elastic bodies 13, the conductor wires 14, and the base members 11, 21 that are in the vicinity of the intersection. When the load sensor 1 has been set on a predetermined installation surface, and a load is applied to an upper face 21a (the face on the Z-axis positive side) of the base member 21 forming a sensor part A1, the capacitance between each electrically-conductive elastic body 13 and the electrically-conductive member in the corresponding conductor wire 14 changes and the load is detected based on the capacitance.

FIGS. 3A, 3B each schematically show a cross section of a sensor part A1 along a plane parallel to a Y-Z plane at the center position in the X-axis direction of the sensor part A1. FIG. 3A shows a state where no load is applied, and FIG. 3B shows a state where loads are applied.

As shown in FIGS. 3A, 3B, each conductor wire 14 is composed of an electrically-conductive member 14a and a dielectric body 14b formed on the electrically-conductive member 14a. The electrically-conductive member 14a is a linear-shaped member that is electrically conductive, and the dielectric body 14b covers the surface of the electrically-conductive member 14a. In FIGS. 3A, 3B, the face on the Z-axis negative side of the base member 11 is set on the installation surface.

As shown in FIG. 3A, when no load is applied, the force applied between the electrically-conductive elastic body 13 and the conductor wire 14, and the force applied between the base member 21 and the conductor wire 14 are substantially zero. From this state, as shown in FIG. 3B, when a load is applied in the downward direction to the upper face 21a of the base member 21 corresponding to the sensor part A1, the electrically-conductive elastic body 13, the electric conductor 12, and the base members 11, 21 are deformed by the conductor wire 14.

As shown in FIG. 3B, when the loads are applied, the conductor wire 14 is brought close to the electrically-conductive elastic body 13 so as to be wrapped by the electrically-conductive elastic body 13, and the contact area between the conductor wire 14 and the electrically-conductive elastic body 13 increases. Accordingly, the capacitance between the electrically-conductive member 14a and the electrically-conductive elastic body 13 changes. Then, change in the capacitance regarding a pair of the conductor wires 14 included in the sensor part A1 is detected, whereby the load applied to the sensor part A1 is calculated.

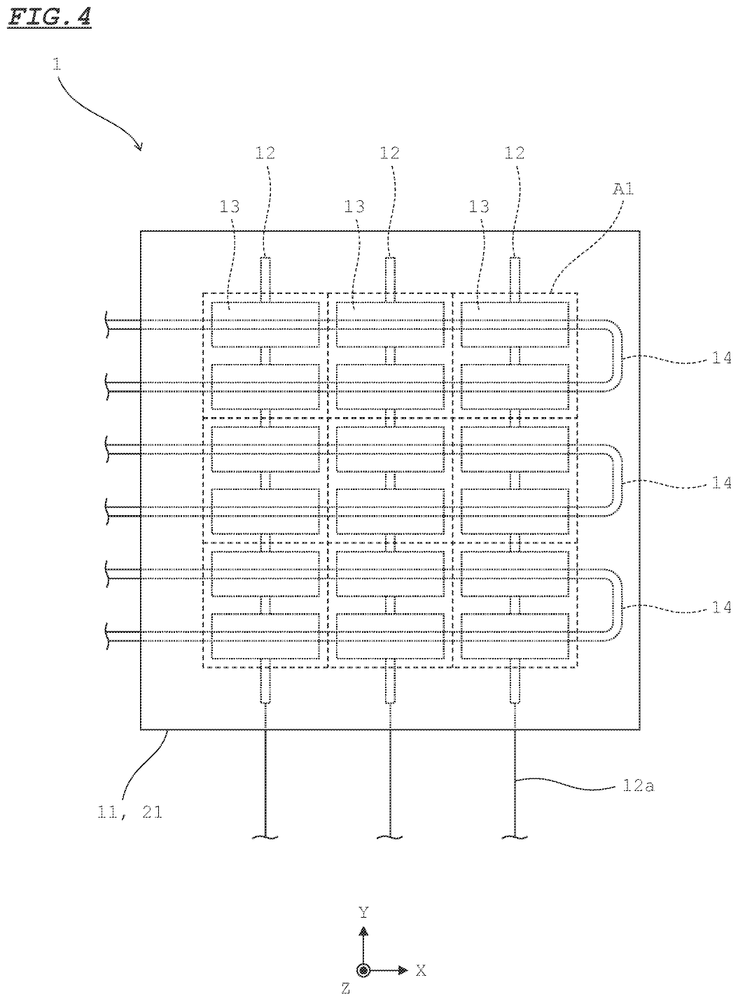

FIG. 4 is a plan view schematically showing the configuration of the inside of the load sensor 1.

The three cables 12a are connected to an external circuit (not shown) including a load detection circuit. Accordingly, the three electric conductors 12 are connected to the external circuit. In addition, in one end portion of each conductor wire 14, the covering dielectric body 14b is removed, whereby the electrically-conductive member 14a is exposed. In each conductor wire 14, this end portion is connected to the external circuit.

The external circuit detects the value of the capacitance for each sensor part A1 while switching the detection target electric conductor 12 and conductor wire 14. Specifically, the external circuit applies a direct-current voltage via a resistor to the electrically-conductive elastic body 13 and the conductor wire 14 crossing each other in the detection target sensor part A1, and measures the voltage value at this crossing position. The voltage value at the crossing position increases according to the time constant defined by the above-mentioned resistor and the capacitance (the capacitance due to the dielectric body 14b between the electrically-conductive elastic body 13 and the electrically-conductive member 14a) at the crossing position.

Here, the capacitance at the crossing position has a magnitude corresponding to the load applied to the crossing position. That is, in accordance with the load applied to the crossing position, the contact area of the dielectric body 14b with respect to the electrically-conductive elastic body 13 changes. The capacitance at the crossing position has a value corresponding to this contact area. At a predetermined timing at which a certain period has elapsed from start of direct-current voltage application, the external circuit measures the voltage value at the crossing position, and based on the measured voltage value, acquires the load in the sensor part A1 corresponding to the crossing position. In this manner, the load in each sensor part A1 is detected.

Meanwhile, the load sensor 1 may be used to detect a load not only during load application and but also during load release. During load release as well, similar to the above, at a predetermined timing after start of direct-current voltage application, the external circuit measures the voltage value in the sensor part A1 (crossing position), and based on the measured voltage value, detects the load in the sensor part A1.

For example, in a use form in which the load sensor 1 is set on the bottom of a shoe, and the load distribution at a sole is monitored, a load when the shoe has touched the ground and a load when the shoe has separated from the ground are monitored from the detection result of the load sensor 1. In this case, the aforementioned external circuit (load detection circuit) detects, for each sensor part A1, the load when the shoe has touched the ground and the load on the upper face of the load sensor 1 increases (during load application), and the load when the shoe has separated from the ground and the load on the upper face of the load sensor 1 decreases (during load release), and transmits the detection result to a monitoring system. The monitoring system monitors whether or not the walking state or the running state is appropriate, based on the received load detection result (load distribution at the sole).

In such a use form, it is preferable that no shift is caused as much as possible between the relationship between the load and the capacitance during load application, and the relationship between the load and the capacitance during load release. Then, the load during load application and the load during load release can be smoothly and accurately detected by the external circuit (load detection circuit).

In the present embodiment, as described above, a plurality of the electrically-conductive elastic bodies 13 are disposed so as to be arranged with a predetermined gap therebetween in the first direction (the Y-axis direction), on the upper face of the base member 11. Accordingly, as described below, a shift between change in the capacitance in the sensor part A1 during load application and change in the capacitance in the sensor part A1 during load release can be suppressed, and the load during load application and the load during load release can be smoothly and accurately detected.

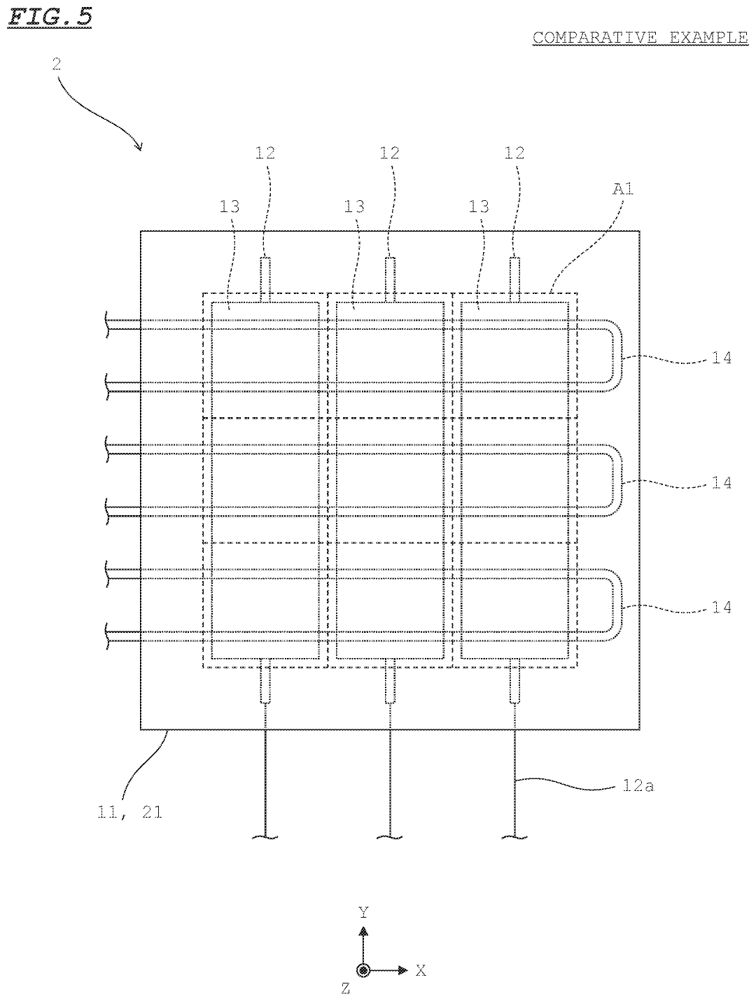

FIG. 5 is a plan view schematically showing the configuration of the inside of a load sensor 2, according to Comparative Example.

In Comparative Example, each electrically-conductive elastic body 13 is continuously, without being cut, formed in the Y-axis direction on the upper face of the base member 11. That is, in Comparative Example, the electrically-conductive elastic body 13 is not divided into pieces with a gap therebetween in the Y-axis direction. In this configuration as well, through a process similar to that in FIG. 4, the external circuit (load detection circuit) can calculate the loads applied to and released from each sensor part A1.

However, in Comparative Example, since the electrically-conductive elastic body 13 is not divided with a gap therebetween in the Y-axis direction, the placement space of the electrically-conductive elastic body 13 relative to the upper face 11a of the base member 11 is large. Meanwhile, since the electrically-conductive elastic body 13 contains the electrically-conductive filler as described above, the electrically-conductive elastic body 13 is harder than the base member 11. Therefore, when the placement space of the electrically-conductive elastic body 13 relative to the upper face 11a of the base member 11 is large as in Comparative Example, the structure (hereinafter, referred to as “elastic structure”) composed of the base member 11, the electric conductor 12, and the electrically-conductive elastic body 13 is less likely to quickly undergo elastic return during load release. As a result, the relationship between the load and the capacitance during load release is likely to be shifted from the relationship between the load and the capacitance during load application.

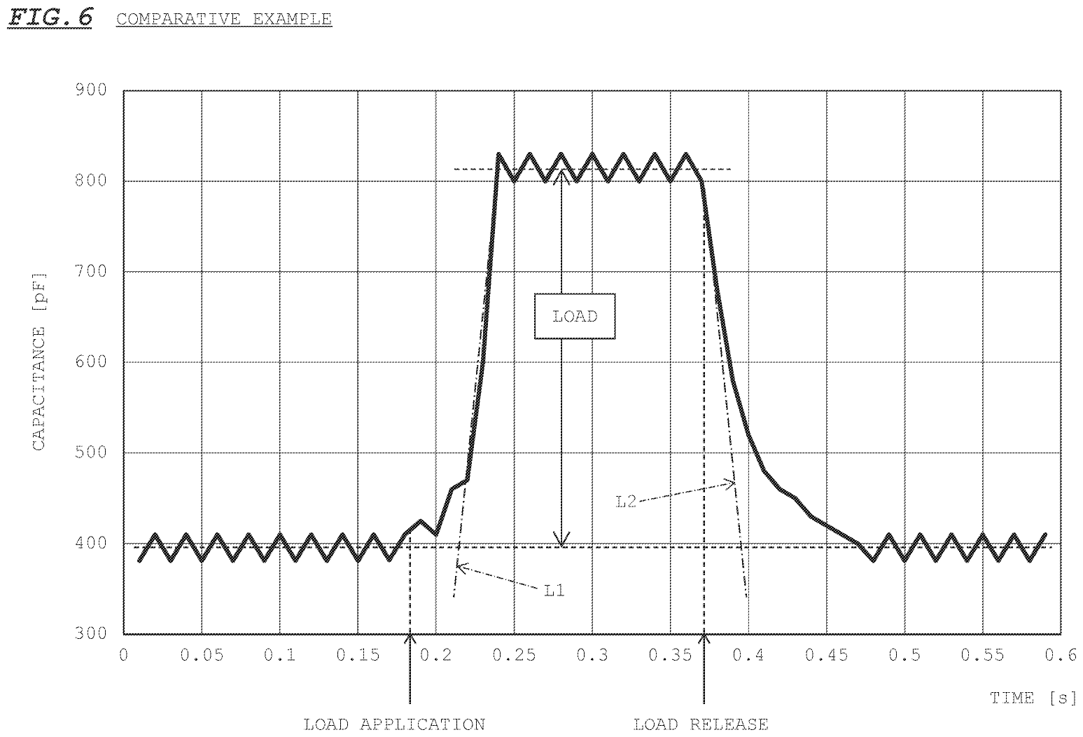

FIG. 6 is a graph schematically showing an example of temporal change in the capacitance during load application and during load release, according to Comparative Example.

In the example shown in FIG. 6, a certain load is applied to the sensor part A1 at the timing of load application in the drawing, and this load is released from the sensor part A1 at the timing of load release in the drawing. The waveform having a small amplitude in the drawing indicates fluctuation of the capacitance due to noise.

The value of the capacitance detected in a state where the load is zero is about 400 pF, and the value of the capacitance detected in a state where the load application has become stable is about 800 pF. When the load is applied at a time on the time axis being near 0.18 s, the value of the capacitance increases in association with the elapsed time until the time reaches near 0.24 s. Then, when the load is released at a time being near 0.37 s, the value of the capacitance decreases in association with the elapsed time until the elapsed time reaches near 0.46 s.

As shown in FIG. 6, for a certain period after the load application, the contact area between the dielectric body 14b and the electrically-conductive elastic body 13 increases due to elastic deformation of the elastic structure. Thus, the capacitance in the sensor part A1 (crossing position) increases in accordance with increase in the contact area. For a certain period after the load release, the contact area between the dielectric body 14b and the electrically-conductive elastic body 13 decreases due to elastic return of the elastic structure. Thus, the capacitance in the sensor part A1 (crossing position) decreases in accordance with decrease in the contact area.

In this case, the slope of the change in the capacitance immediately after the load release is gentle as compared with a straight line L2 obtained by left-right inverting a straight line L1 indicating the change in the capacitance during load application. The slope of the change in the capacitance during load release is further gentler when the time is 0.4 s and thereafter. That is, in the latter half during load release, the speed of the value of the capacitance returning to the level (near 400 pF) of the load 0 is further slower.

Thus, changes in the capacitance during load application and during load release are not in symmetry, and change in the capacitance during load release is gentle as compared with that during load application. That is, in the case of Comparative Example, since elastic return of the electrically-conductive elastic body 13 during load release is slow, the capacitance is less likely to quickly return to the level of the load 0.

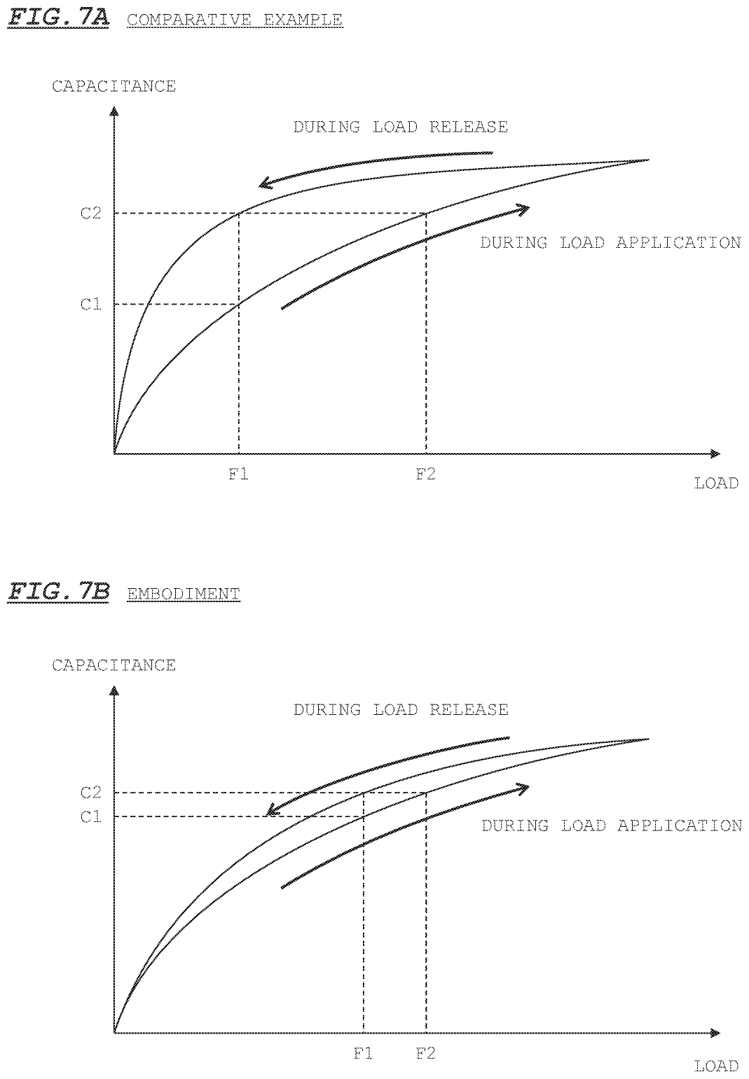

FIG. 7A is a graph schematically showing the relationship between the load and the capacitance, according to Comparative Example.

The graph in FIG. 7A schematically shows change in the capacitance in the sensor part A1 (crossing position) when the load applied to the sensor part A1 (crossing position) is increased at a constant speed from zero to a certain value, and then the load is decreased at a similar speed. The horizontal axis in FIG. 7A represents the magnitude of the applied load, and the vertical axis in FIG. 7A is the capacitance in the sensor part A1 (crossing position).

In the case of Comparative Example, as shown in FIG. 5, the electrically-conductive elastic body 13 is continuously formed without any gap in the Y-axis direction so as to extend across all the conductor wires 14. Thus, as described above, the elastic structure is less likely to undergo elastic return. Therefore, as compared with the speed of elastic deformation of the electrically-conductive elastic body 13 at the crossing position with the conductor wires 14 during load application, the speed of elastic return of the electrically-conductive elastic body 13 at the crossing position during load release becomes slow.

As a result, as shown in FIG. 7A, the relationship between the load and the capacitance during load release is separated from the relationship between the load and the capacitance during load application. Therefore, for example, with respect to an identical load F1, during load application and during load release, capacitances C1, C2 different from each other are caused. In addition, even though the same capacitance C2 is acquired during load application and during load release, loads F1, F2 different from each other are detected in the end.

FIG. 7B is a graph schematically showing the relationship between the load and the capacitance, according to the embodiment.

In the case of the embodiment, as shown in FIG. 4, the electrically-conductive elastic bodies 13 are formed so as to be separated in the Y-axis direction for the respective conductor wires 14. Thus, influence of the electrically-conductive elastic body 13 when the elastic structure undergoes elastic return becomes small, and the elastic structure is more likely to undergo elastic return as compared with Comparative Example. Therefore, the speed of elastic return of the electrically-conductive elastic body 13 at the crossing position with the conductor wire 14 during load release is brought close to the speed of elastic deformation of the electrically-conductive elastic body 13 at the crossing position during load application.

As a result, as shown in FIG. 7B, the relationship between the load and the capacitance during load release can be brought close to the relationship between the load and the capacitance during load application. Accordingly, for example, with respect to the identical load F1, the values of the capacitances C1, C2 respectively acquired during load application and during load release are brought close to each other as compared with those in FIG. 7A. In addition, during load application and during load release, the values of the loads F1, F2 acquired with respect to the same capacitance C2 are brought close to each other as compared with those in FIG. 7A. Therefore, according to the configuration of the embodiment, the difference between the detected load during load application and the detected load during load release is suppressed. Thus, the loads can be smoothly and accurately detected.

Next, a preferable range of the width in the Y-axis direction of the electrically-conductive elastic body 13 will be described.

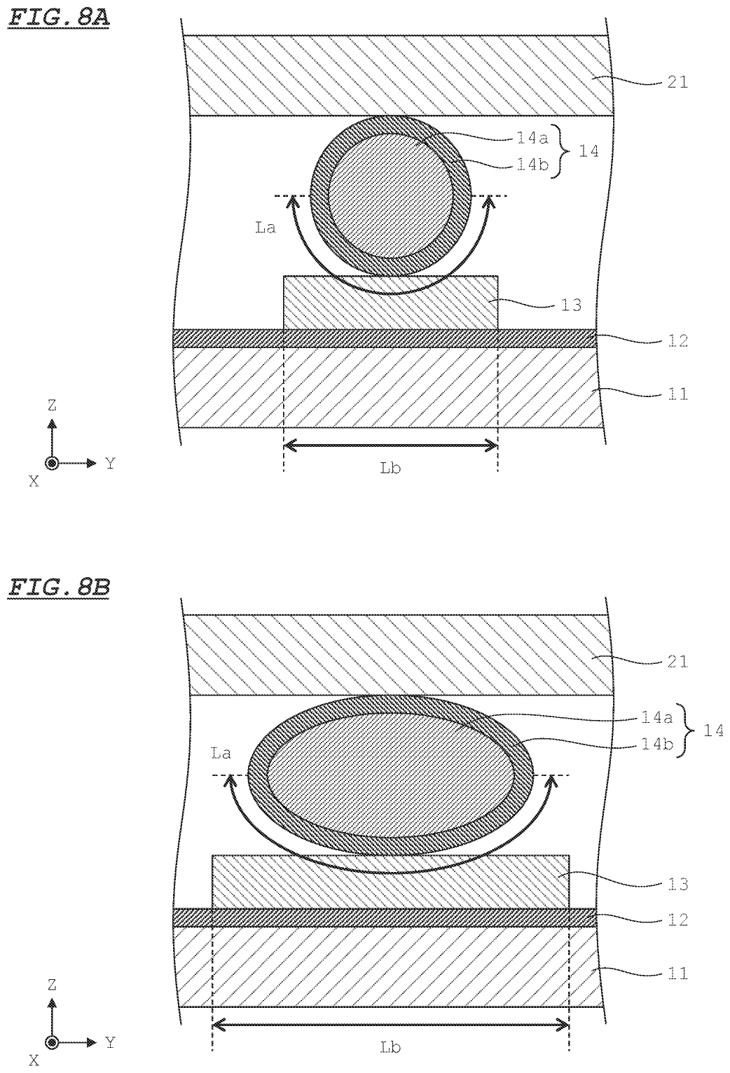

FIG. 8A schematically shows a cross section of the vicinity of the electrically-conductive elastic body 13 and the conductor wire 14 along a plane parallel to a Y-Z plane at the center position in the X-axis direction of the sensor part A1.

In the present embodiment, the cross section along a Y-Z plane of the conductor wire 14 has a circular shape. In this case, a length La of the outer periphery of the lower half in the cross section having a circular shape of the conductor wire 14 is the upper limit contact width at which the electrically-conductive elastic body 13 is able to be in contact with the electrically-conductive member 14a via the dielectric body 14b in the Y-axis direction. It is preferable that a width Lb in the Y-axis direction of the electrically-conductive elastic body 13 is not greater than the upper limit contact width. That is, it is preferable that the length La and the width Lb is defined by Formula (1) below.

La≥Lb (1)

In the case of FIG. 8A, when the radius of the cross section having a circular shape of the conductor wire 14 is defined as r, the length La is represented by πr. Therefore, the upper limit contact width becomes πr, and it is preferable that the width Lb in the Y-axis direction of the electrically-conductive elastic body 13 is set to be not greater than πr.

When the width Lb is set in this manner, the placement space of the electrically-conductive elastic body 13 can be effectively suppressed. That is, when the width Lb is larger than the upper limit contact width, the portion in the width of the electrically-conductive elastic body 13 that exceeds the upper limit contact width does not come into contact with electrically-conductive member 14a, no matter how much the load is increased. Thus, this portion in the width neither contributes to increase in the contact area, nor contributes to increase in the capacitance. Therefore, when this portion in the width is reduced, and the width Lb in the Y-axis direction of the electrically-conductive elastic body 13 is set to be not greater than the upper limit contact width, change in the capacitance corresponding to change in the contact area can be appropriately detected, and at the same time, the placement space of the electrically-conductive elastic body 13 can be effectively suppressed.

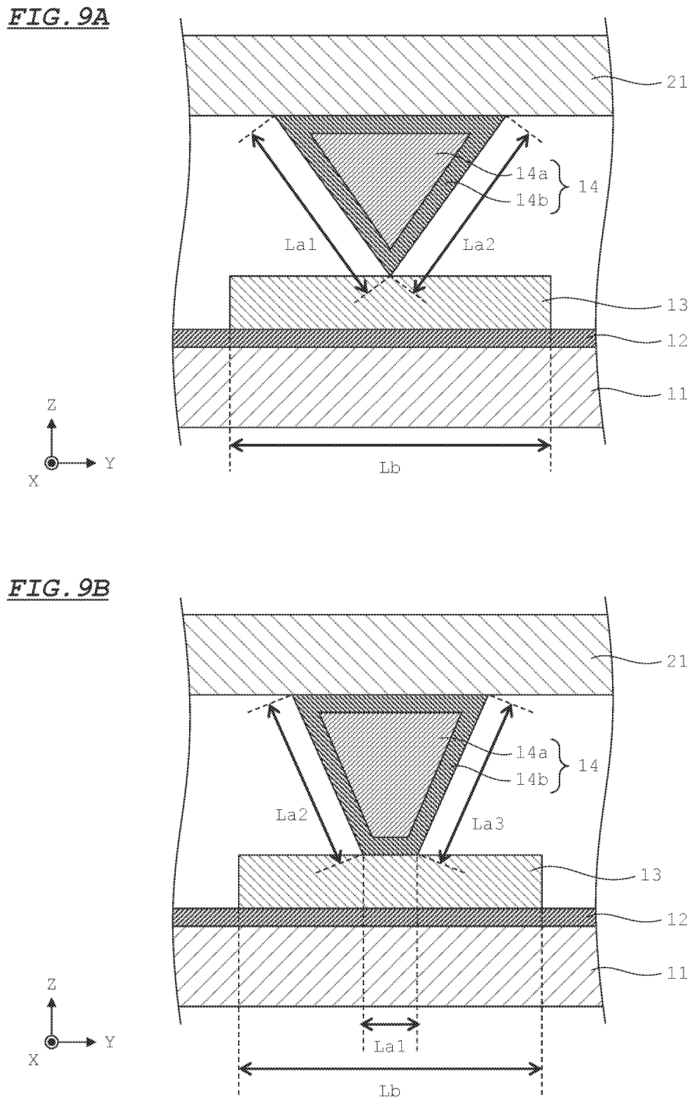

The cross section along a Y-Z plane of the conductor wire 14 may be a shape other than a circular shape. For example, the cross section of the conductor wire 14 may have a shape shown in FIG. 8B to FIG. 9B.

FIG. 8B schematically shows a modification in which the cross section along a Y-Z plane of the conductor wire 14 has an ellipse shape.

In this case, the length of the outer periphery of the lower half in the cross section having an ellipse shape of the conductor wire 14 corresponds to the length La in Formula (1), and is the upper limit contact width at which the electrically-conductive elastic body 13 is able to be in contact with the electrically-conductive member 14a via the dielectric body 14b. In this case as well, when the width Lb in the Y-axis direction of the electrically-conductive elastic body 13 is set to be not greater than the upper limit contact width according to Formula (1), the placement space of the electrically-conductive elastic body 13 can be effectively suppressed.

FIG. 9A schematically shows a modification in which the cross section along a Y-Z plane of the conductor wire 14 has a triangular shape.

In this modification, in a state where a vertex of the triangular shape of the cross section of the conductor wire 14 is oriented downwardly so as to be in contact with the electrically-conductive elastic body 13, the conductor wire 14 is disposed between the electrically-conductive elastic body 13 and the base member 21. In this case, a length (La1+La2) obtained by adding the lengths La1, La2 of two sides connected to the vertex of the triangular shape of the cross section of the conductor wire 14 corresponds to the length La in Formula (1), and is the upper limit contact width at which the electrically-conductive elastic body 13 is able to be in contact with the electrically-conductive member 14a via the dielectric body 14b. In this case as well, when the width Lb in the Y-axis direction of the electrically-conductive elastic body 13 is set to be not greater than the upper limit contact width according to Formula (1), the placement space of the electrically-conductive elastic body 13 can be effectively suppressed.

FIG. 9B schematically shows a modification in which the cross section along a Y-Z plane of the conductor wire 14 has a trapezoid shape.

In this modification, in a state where the trapezoid shape of the cross section of the conductor wire 14 is oriented downwardly, the conductor wire 14 is disposed between the electrically-conductive elastic body 13 and the base member 21. In the trapezoid shape of the cross section of the conductor wire 14, when the length of the side in contact with the electrically-conductive elastic body 13 is defined as La1, and the lengths of the two sides connected to the side having the length La1 are respectively defined as La2, La3, the length (La1+La2+La3) obtained by adding the lengths La1, La2, La3 corresponds to the length La in Formula (1), and is the upper limit contact width at which the electrically-conductive elastic body 13 is able to be in contact with the electrically-conductive member 14a via the dielectric body 14b. In this case as well, when the width Lb in the Y-axis direction of the electrically-conductive elastic body 13 is set to be not greater than the upper limit contact width according to Formula (1), the placement space of the electrically-conductive elastic body 13 can be effectively suppressed.

In a case where the cross-sectional shape of the conductor wire 14 has a shape other than those in FIG. 8A to FIG. 9B as well, when the width Lb in the Y-axis direction of the electrically-conductive elastic body 13 is set to be not greater than the upper limit contact width according to Formula (1), the placement space of the electrically-conductive elastic body 13 can be effectively suppressed.

Next, a preferable relationship between the widths in the X-axis direction of the electrically-conductive elastic body 13 and the electric conductor 12 will be described.

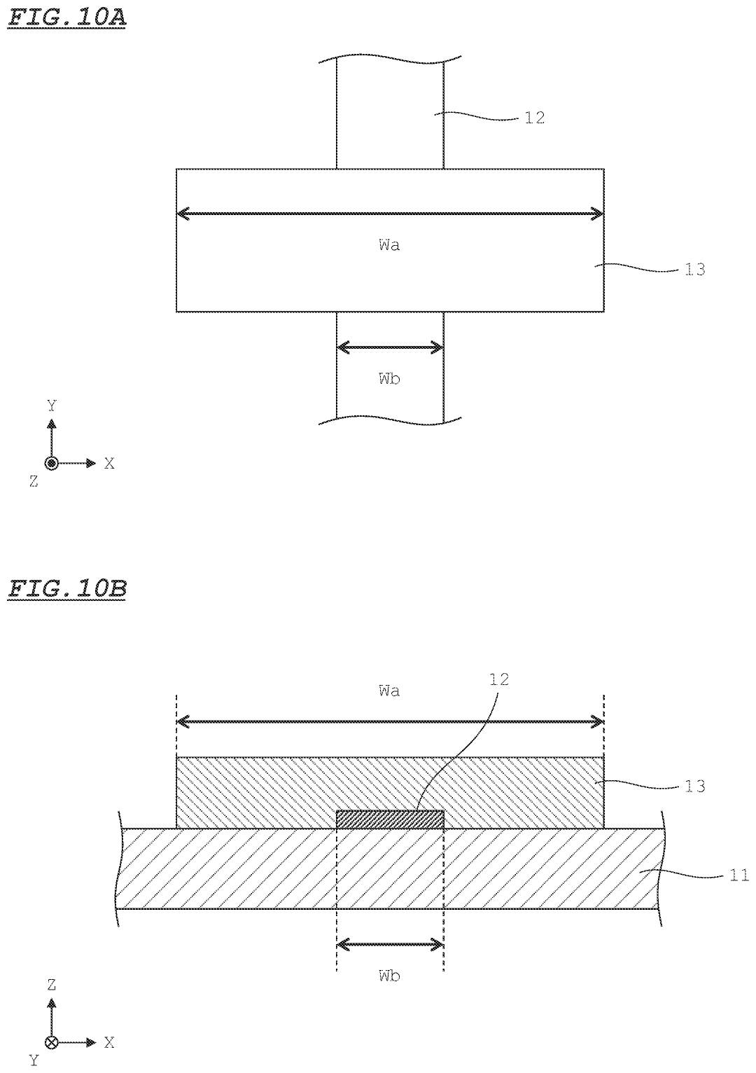

FIG. 10A is a plan view schematically showing the configurations of the electrically-conductive elastic body 13 and the electric conductor 12 near a position where the electrically-conductive elastic body 13 and the electric conductor 12 overlap each other. FIG. 10B schematically shows a cross section of the base member 11, the electric conductor 12, and the electrically-conductive elastic body 13 along a plane parallel to an X-Z plane near a position where the electrically-conductive elastic body 13 and the electric conductor 12 overlap each other.

As shown in FIGS. 10A, 10B, when the width in the X-axis direction of the electrically-conductive elastic body 13 is defined as Wa, and the width in the X-axis direction of the electric conductor 12 is defined as Wb, it is preferable that the widths Wa, Wb are defined by Formula (2) below.

Wa>Wb (2)

When the widths Wa, Wb are defined as in Formula (2) above, at the position (near the center position in the Y-axis direction of the electrically-conductive elastic body 13) where the conductor wire 14 passes, the electric conductor 12 is inhibited from protruding to the outer side in the X-axis direction of the electrically-conductive elastic body 13. Accordingly, the conductor wire 14 can be prevented from coming into contact with the electric conductor 12 protruding from the electrically-conductive elastic body 13.

### Effects of the Embodiment

According to the embodiment, the following effects are exhibited.

The electrically-conductive elastic bodies 13 are disposed on the upper face 11a of the base member 11 and are arranged in the first direction (the Y-axis direction) with a predetermined gap therebetween. A plurality of the electrically-conductive members 14a each having a linear shape extend in the second direction (the X-axis direction) and cross the plurality of the electrically-conductive elastic bodies 13. The dielectric body 14b is disposed between the electrically-conductive elastic body 13 and the electrically-conductive member 14a.

With this configuration, since the plurality of the electrically-conductive elastic bodies 13 are disposed with a gap therebetween, the placement space of the electrically-conductive elastic bodies 13 relative to the upper face 11a of the base member 11 is suppressed. Therefore, the elastic structure composed of the base member 11, the electric conductor 12, and the electrically-conductive elastic body 13 is more likely to quickly undergo elastic return during load release. As a result, as shown in FIG. 7B, the relationship between the load and the capacitance during load release can be brought close to the relationship between the load and the capacitance during load application. That is, it is possible to suppress occurrence of a shift in the relationship between the load and the capacitance between during load application and during load release.

Since the placement space of the electrically-conductive elastic bodies 13 can be suppressed, the use amount of the electrically-conductive elastic bodies 13 can be reduced, and the weight of the load sensor 1 can be reduced. In addition, when the electrically-conductive elastic bodies 13 are printed on the upper face 11a of the base member 11, the printing step is simplified, and thus, the use amount of ink and poor printing can be suppressed.

As shown in FIG. 8A to FIG. 9B, the width Lb of the electrically-conductive elastic body 13 in a direction (the Y-axis direction) perpendicular to the second direction (the X-axis direction) is not greater than the upper limit contact width (La) at which the electrically-conductive elastic body 13 is able to be in contact with the electrically-conductive member 14a via the dielectric body 14b. Accordingly, the width of the electrically-conductive elastic body 13 can be restricted within the range of the upper limit contact width, and thus, the placement space of the electrically-conductive elastic body 13 can be effectively suppressed and the elastic structure is allowed to more quickly undergo elastic return during load release. Since the width of the electrically-conductive elastic body 13 is within the range of the upper limit contact width, the load at the crossing position between the electrically-conductive elastic body 13 and the electrically-conductive member 14a can be appropriately detected.

The electric conductor 12 is formed so as to have a resistance lower than that of the electrically-conductive elastic body 13. The electric conductor 12 is disposed, while being covered by the electrically-conductive elastic body 13, on the upper face 11a of the base member 11, and is connected to the external circuit. Since the electric conductor 12 is disposed, the resistance value between the external circuit and the upper face of the electrically-conductive elastic body 13 can be decreased. Accordingly, the detection sensitivity at each crossing position between the conductor wire 14 and the electrically-conductive elastic body 13 can be increased.

The electric conductor 12 extends in the first direction (the Y-axis direction) so as to cross the plurality of the electrically-conductive elastic bodies 13. Accordingly, the plurality of the electrically-conductive elastic bodies 13 can be connected to the external circuit by a single electric conductor 12, whereby the configuration can be simplified.

The electric conductor 12 has elasticity. Accordingly, the electric conductor 12 can be suppressed from having influence on the elasticity of the electrically-conductive elastic body 13. Therefore, the load detection at each crossing position between the conductor wire 14 and the electrically-conductive elastic body 13 can be more appropriately performed.

The electrically-conductive elastic body 13 contains carbon particles and the electric conductor 12 contains metal particles. Accordingly, the electrically-conductive elastic body 13 can be formed to be soft, and the resistivity of the electric conductor 12 can be made small.

As shown in FIGS. 10A, 10B, the width Wa of the electrically-conductive elastic body 13 in a direction (the X-axis direction) perpendicular to the first direction (the Y-axis direction) is larger than the width Wb of the electric conductor 12 in the direction perpendicular to the first direction. Accordingly, the electrically-conductive member 14a can be prevented from coming into contact with the electric conductor 12 protruding from the electrically-conductive elastic body 13. Therefore, for each position where the electrically-conductive elastic body 13 and the electrically-conductive member 14a cross each other, the load can be accurately detected. When the dielectric body 14b is formed on the outer periphery of the electrically-conductive member 14a, contact between the electric conductor 12 and the dielectric body 14b is avoided. Therefore, peeling-off of the dielectric body 14b on the electrically-conductive member 14a can be prevented. Further, since the width Wb of the electric conductor 12 is small as compared with the width Wa of the electrically-conductive elastic body 13, the electric conductor 12 can be suppressed from having influence on the elasticity of the elastic structure.

One electrically-conductive member 14a is disposed on the upper face of one electrically-conductive elastic body 13. Accordingly, the width of the electrically-conductive elastic body 13 in the first direction (the Y-axis direction) can be minimized. Therefore, the difference in the relationship between the load and the capacitance between during load application and during load release can be most suppressed.

A plurality of rows each composed of the plurality of the electrically-conductive elastic bodies 13 are disposed in the second direction (the X-axis direction). Accordingly, the crossing positions between the electrically-conductive elastic bodies 13 and the electrically-conductive members 14a can be disposed in a matrix shape. Therefore, the loads can be detected in a larger range.

The electrically-conductive member 14a is configured such that a cross section thereof has a circular shape. Accordingly, change in the contact area with respect to the load can be smoothly caused.

The dielectric body 14b is formed so as to cover the outer periphery of the electrically-conductive member 14a. Accordingly, by merely covering the surface of the electrically-conductive member 14a with the dielectric body 14b, it is possible to dispose the dielectric body 14b between the electrically-conductive elastic body 13 and the electrically-conductive member 14a.

### Modification

The configuration of the load sensor 1 can be modified in various ways other than the configuration shown in the above embodiment.

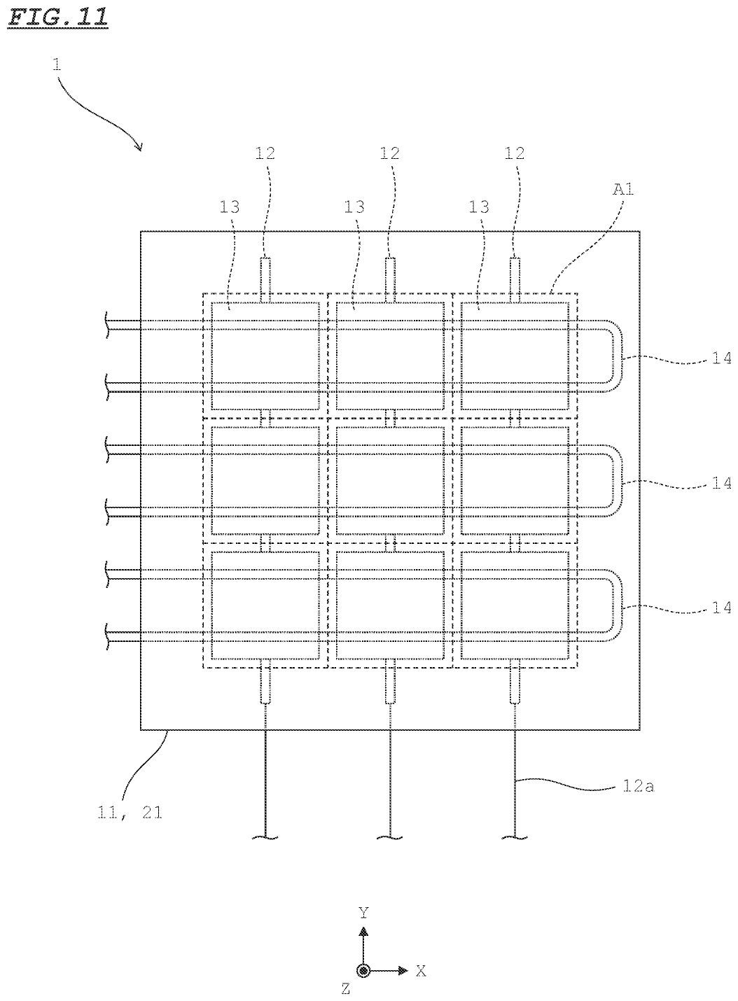

For example, in the above embodiment, one conductor wire 14 is disposed on the upper face of one electrically-conductive elastic body 13, with respect to the plurality of the electrically-conductive elastic bodies 13 arranged in the Y-axis direction. However, a plurality of the conductor wires 14 may be disposed on the upper face of one electrically-conductive elastic body 13, with respect to the plurality of the electrically-conductive elastic bodies 13 arranged in the Y-axis direction. For example, as shown in FIG. 11, two conductor wires 14 may be disposed on the upper face of one electrically-conductive elastic body 13, with respect to the plurality of the electrically-conductive elastic bodies 13 arranged in the Y-axis direction. In this case, the division number of the electrically-conductive elastic body 13 in the Y-axis direction is set to be three. One electrically-conductive elastic body 13 is disposed in one sensor part A1, and two conductor wires 14 are disposed on the upper face of the electrically-conductive elastic body 13 in each sensor part A1.

In this case as well, the electrically-conductive elastic body 13 is divided in the Y-axis direction. Thus, as compared with Comparative Example shown in FIG. 5, the elastic structure is more likely to quickly undergo elastic return. When a plurality of the electrically-conductive members 14a (the conductor wires 14) are disposed on the upper face of one electrically-conductive elastic body 13 in this manner, the disposition step of the electrically-conductive elastic body 13 can be simplified. Other than this, when the disposition number of the sensor parts A1 in the Y-axis direction is an even number, the electrically-conductive elastic body 13 may be divided into two to be disposed in the Y-axis direction.

In the above embodiment, the angle between the direction in which the electric conductor 12 extends and the direction in which the conductor wire 14 extends is 90°. However, the angle may be an angle other than 90°. When the angle is an angle other than 90° as well, the plurality of the electrically-conductive elastic bodies 13 are disposed so as to be arranged with a predetermined gap therebetween in the direction in which the electric conductor 12 extends.

In the above embodiment, the electric conductor 12 is formed from a material having elasticity and an electrically-conductive filler dispersed in the material, but may be formed from an electrically-conductive material having substantially no elasticity. In this case, the resistivity of the electric conductor 12 can be further decreased, but the elasticity of the elastic structure composed of the base member 11, the electric conductor 12, and the electrically-conductive elastic body 13 decreases. Therefore, as in the above embodiment, it is preferable that the electric conductor 12 is formed from an elastic material and an electrically-conductive filler.

In the above embodiment, the plurality of the electrically-conductive elastic bodies 13 arranged in the Y-axis direction are electrically connected with each other by the electric conductor 12, to be connected to the external circuit. However, the means for connecting the electrically-conductive elastic bodies 13 to the external circuit is not limited to the above. For example, an electric conductor drawn from each electrically-conductive elastic body 13 may be connected to the external circuit so as not to come into contact with the conductor wire 14.

In the above embodiment, a pair of the conductor wires 14 adjacent to each other in the Y-axis direction are connected at an end portion on the X-axis positive side, but may be separated in the end portion on the X-axis positive side. That is, separate conductor wires 14 may be disposed so as to be arranged in the Y-axis direction. In this case, two conductor wires 14 passing through one sensor part A1 are connected to each other in an external circuit in a later stage.

In the above embodiment, the load sensor 1 includes three pairs of the conductor wires 14, but may include one pair or more of the conductor wires 14. For example, the number of the pairs of the conductor wires 14 included in the load sensor 1 may be one. Further, each sensor part A1 of the load sensor 1 includes two conductor wires 14 arranged in the Y-axis direction, but may include one or more conductor wires 14. For example, the number of the conductor wires 14 included in the sensor part A1 may be one. When the sensor part A1 of the load sensor 1 includes three or more conductor wires 14 arranged in the Y-axis direction, these conductor wires 14 may be connected at an end portion in the X-axis direction, or may be connected to each other in an external circuit in a later stage.

In the above embodiment, the load sensor 1 includes three rows each composed of six electrically-conductive elastic bodies 13 arranged in the Y-axis direction, but may include at least one row of the electrically-conductive elastic bodies 13. For example, the number of the rows of the electrically-conductive elastic bodies 13 included in the load sensor 1 may be one.

In the above embodiment, each electrically-conductive member 14a is implemented by one wire member, but may be implemented by a twisted wire obtained by twisting a plurality of wire members. In this case as well, it is preferable that the cross section of the twisted wire has a substantially circular shape such that the contact area smoothly increases in accordance with the load. The cross section of the twisted wire may have a shape other than a circular shape.

In the above embodiment, the sensor part A1 includes the electrically-conductive elastic body 13 only on the lower side of the conductor wire 14. However, not limited thereto, the sensor part A1 may include an electrically-conductive elastic body also on the upper side of the conductor wire 14.

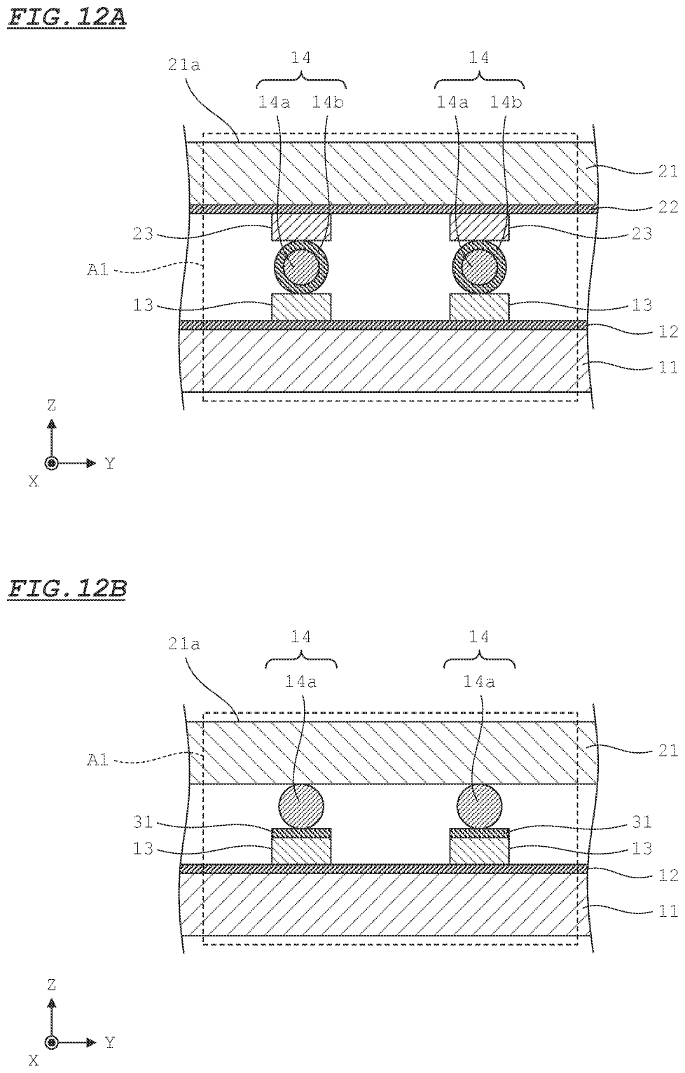

FIG. 12A schematically shows the configuration of a modification in which an electric conductor 22 and an electrically-conductive elastic body 23 are disposed on the upper side of the conductor wire 14.

In this case, similar to the electric conductor 12 and the electrically-conductive elastic body 13 formed on the base member 11, the electric conductor 22 and the electrically-conductive elastic body 23 are formed on the lower face of the base member 21. The size, thickness, and material of the electric conductor 22 are configured similarly to those of the electric conductor 12, and the size, thickness, and material of the electrically-conductive elastic body 23 are configured similarly to those of the electrically-conductive elastic body 13. When viewed in the Z-axis direction, the electric conductor 22 is disposed at the same position as that of the electric conductor 12, and the electrically-conductive elastic body 23 is disposed at the same position as that of the electrically-conductive elastic body 13.

In this configuration example, as shown in FIG. 12A, the base member 21 (another base member) is disposed so as to oppose the upper face 11a of the base member 11. A plurality of the electrically-conductive elastic bodies 23 (other electrically-conductive elastic bodies) are disposed on the lower face of the base member 21 and are arranged in the first direction (the Y-axis direction) with a predetermined gap therebetween. The plurality of the electrically-conductive elastic bodies 23 are disposed so as to respectively oppose the plurality of the electrically-conductive elastic bodies 13, for example. The dielectric body 14b is disposed between each of the plurality of the electrically-conductive elastic bodies 23 and the electrically-conductive member 14a.

With this configuration, in accordance with the load, not only the contact area between the conductor wire 14 and the electrically-conductive elastic body 13, but also the contact area between the conductor wire 14 and the electrically-conductive elastic body 23 changes. Therefore, as compared with the cases in FIGS. 3A, 3B, change in the contact area during load application is large. Therefore, the load detection sensitivity of the load sensor 1 can be increased. In addition, similar to the electrically-conductive elastic bodies 13 on the lower side, the electrically-conductive elastic bodies 23 on the upper side are disposed with a predetermined gap therebetween in the Y-axis direction. Therefore, the elastic structure composed of the base member 21, the electric conductor 22, and the electrically-conductive elastic body 23 is more likely to quickly undergo elastic return.

The plurality of the electrically-conductive elastic bodies 23 on the upper side and the plurality of the electrically-conductive elastic bodies 13 on the lower side need not necessarily be disposed in a one-to-one relationship. For example, six electrically-conductive elastic bodies 13 on the lower side may be disposed in the Y-axis direction as shown in FIG. 4, and three electrically-conductive elastic bodies 23 on the upper side may be disposed in the Y-axis direction, similar to the electrically-conductive elastic bodies 13 in FIG. 11.

In the above embodiment, the dielectric body 14b is disposed so as to cover the electrically-conductive member 14a. However, instead of this, the dielectric body may be disposed on an opposing face of the electrically-conductive elastic body 13.

FIG. 12B schematically shows the configuration of a modification in which a dielectric body 31 is disposed on the opposing face (upper face) of the electrically-conductive elastic body 13. In this case, when a load is applied to the sensor part A1, the electrically-conductive member 14a (the conductor wire 14) relatively moves toward the electrically-conductive elastic body 13, whereby the contact area between the electrically-conductive member 14a and the dielectric body 31 changes. Accordingly, the capacitance between the electrically-conductive elastic body 13 and the electrically-conductive member 14a changes, and thus, the load in each sensor part A1 can be detected. In the configuration in FIG. 12B as well, similar to FIG. 12A, the electric conductor 22 and the electrically-conductive elastic body 23 may be formed on the lower face of the base member 21, and the dielectric body may be disposed on the opposing face (the lower face) of the electrically-conductive elastic body 23.

In addition to the above, various modifications can be made as appropriate to the embodiment of the present invention without departing from the scope of the technical idea defined by the claims.

What is claimed is:

1. A load sensor comprising:
a base member;
a plurality of electrically-conductive elastic bodies disposed on an upper face of the base member and arranged in a first direction with a predetermined gap therebetween;
a plurality of electrically-conductive members each having a linear shape and extending in a second direction, the plurality of electrically-conductive members crossing the plurality of electrically-conductive elastic bodies; and
a dielectric body disposed between the electrically-conductive elastic body and the electrically-conductive member.

2. The load sensor according to claim 1, wherein
a width of the electrically-conductive elastic body in a direction perpendicular to the second direction is not greater than an upper limit contact width at which the electrically-conductive elastic body is able to be in contact with the electrically-conductive member via the dielectric body.

3. The load sensor according to claim 1, wherein
an electric conductor having a resistance lower than that of the electrically-conductive elastic body is disposed, while being covered by the electrically-conductive elastic body, on the upper face of the base member, and
the electric conductor is connected to an external circuit.

4. The load sensor according to claim 3, wherein
the electric conductor extends in the first direction so as to cross the plurality of electrically-conductive elastic bodies.

5. The load sensor according to claim 3, wherein
the electric conductor has elasticity.

6. The load sensor according to claim 5, wherein
the electrically-conductive elastic body contains carbon particles, and
the electric conductor contains metal particles.

7. The load sensor according to claim 3, wherein
a width of the electrically-conductive elastic body in a direction perpendicular to the first direction is larger than a width of the electric conductor in the direction perpendicular to the first direction.

8. The load sensor according to claim 1, wherein
one said electrically-conductive member is disposed on an upper face of one said electrically-conductive elastic body.

9. The load sensor according to claim 1, wherein
the plurality of electrically-conductive members are disposed on an upper face of one said electrically-conductive elastic body.

10. The load sensor according to claim 1, wherein
a plurality of rows each composed of the plurality of electrically-conductive elastic bodies are disposed in the second direction.

11. The load sensor according to claim 1, wherein
the electrically-conductive member is configured such that a cross section thereof has a circular shape.

12. The load sensor according to claim 1, wherein
the dielectric body is formed so as to cover an outer periphery of the electrically-conductive member.

13. The load sensor according to claim 1, comprising:
another base member disposed so as to oppose the upper face of the base member;
a plurality of other electrically-conductive elastic bodies disposed on a lower face of the other base member and arranged in the first direction with a predetermined gap therebetween; and
a dielectric body disposed between each of the plurality of other electrically-conductive elastic bodies and the electrically-conductive member, wherein
the electrically-conductive member is disposed between the electrically-conductive elastic body and the other electrically-conductive elastic body.
